(19) United States
(12) Patent Application Publication
(10) Pub. No.: US 2025/0197035 A1
(43) Pub. Date: Jun. 19, 2025

(54) MOBILE ORBITAL LAUNCHER

(71) Applicant: AGNIKUL COSMOS PRIVATE LIMITED, Chennai (IN)

(72) Inventors: Syed Peer Mohamed Shah Khadri ., Chennai (IN); Srinath RAVICHANDRAN, Chennai (IN)

(21) Appl. No.: 18/701,531

(22) PCT Filed: Oct. 3, 2022
(86) PCT No.: PCT/IN2022/050880

§ 371 Date: Apr. 15, 2024

(30) Foreign Application Priority Data
Oct. 14, 2021 (IN) 202141046990

(51) Int. Cl. B64G 5/00

(52) U.S. Cl. CPC B64G 5/00; B64G 2005/005

(57) ABSTRACT

The present invention relates to a system and method of mobile orbital launchers. The mobile launcher of the present invention mainly consists of the launch vehicle and launch related subsystems. All the systems will fit on a trailer which is capable of going anywhere via road or sea. It will carry the vehicle in a horizontal position and after reaching the required location, it will articulate and make the vehicle vertical to get ready for launch. The system and method of the present invention have all the subsystems which enable the launch without any hindrance.

### FIELD OF INVENTION

The present invention relates to mobile orbital launchers. More specifically, to launch related launch vehicles to any desired orbit through land or sea.

### BACKGROUND OF INVENTION

Satellite launchers or satellite launch vehicles are used to carry satellites, spacecraft, rockets to space. India has two operational launchers: Polar Satellite Launch Vehicle (PSLV) and Geosynchronous Satellite Launch Vehicle (GSLV).

Space logistics is a specialized area in the aerospace industry. A maintainable space study is impossible without suitable logistics.

The conventional launch pad designs are not very flexible with respect to the launch location. They can go only on a defined path to the predefined locations but our system can go to any desired location via road or sea to any required location and launch.

There are several prior-arts in this technology area of space logistics.

The patent application US20180210615A1 discloses a system, method, and computer program product embodiments for a tile interface and launchpad system. An embodiment operates by providing a user interface with a plurality of tiles. An indication is received to move the first tile from the first section of the user interface to a second section of the user interface. The first tile as displayed in the first section includes a first selection of information, and tiles of the second section include a section selection of information. The visual appearance of the first tile is modified, and the second selection of information is displayed in the first tile.

The patent EP2662287B1 discloses a multiple space vehicle launch system by utilizing electrical propulsion motors in the space vehicles, the total mass of the space vehicle may be significantly reduced when compared to a space vehicle having a chemical propulsion motor, which may enable support structures such as Sylda to be eliminated.

The patent US5884866A discloses a dispenser that is connectable to a launch vehicle in order to deploy a plurality of satellites in orbit. The dispenser includes a post having a longitudinal axis, an assembly for coupling the post to a launch vehicle, and a plurality of fittings coupled to the post and having attachment means for deployable coupling a satellite to the post. The attachment means is aligned substantially orthogonal to the longitudinal axis of the post and defines attachment bays extending annularly about the post.

The patent application WO2011005422A3 discloses launch vehicle systems and methods for landing and recovering a booster stage and/or other portions thereof on a platform at sea or on another body of water are disclosed In one embodiment, a reusable space launch vehicle is launched from a coastal launch site in a trajectory over water. After booster engine cutoff and upper stage separation, the booster stage re-enters the earth's atmosphere in a tail-first orientation. The booster engines are then restarted and the booster stage performs a vertical powered landing on the deck of a pre-positioned sea-going platform In one embodiment, bi-directional aerodynamic control surfaces control the trajectory of the booster stage as it glides through the earth's atmosphere toward the sea-going platform. The sea-going platform can broadcast its real-time position to the booster stage so that the booster stage can compensate for errors in the position of the sea-going platform due to current drift.

However, the prior-arts do not disclose a system for satellite launchers and logistics that can go through the road to any predefined launch location or can load on the ship and carry to any predefined offshore location.

Hence, the present invention has developed a mobile launcher characterized with subsystems that can load and reach any desired location through land or sea in order to launch.

### OBJECTIVE OF THE INVENTION

The primary objective of the invention is to develop a mobile orbital launcher system which has all the subsystems that make sure the launching vehicle to any desired orbit through any launch location, such that the launcher may travel via land or sea.

### SUMMARY OF THE INVENTION

The following summary is provided to facilitate a clear understanding of the new features in the disclosed embodiment and it is not intended to be a full, detailed description. A detailed description of all the aspects of the disclosed invention can be understood by reviewing the full specification, the drawing, and the claims, and the abstract, as a whole.

The present invention has developed a system in such a way that the launcher system can carry the orbital payload carrying launch vehicle to any required location and launch the same.

In another aspect of the present invention, the system can carry the satellite launch vehicle along with all the subsystems related to launching on a vehicle which can go via road or sea based on the requirement and launch at the required time.

In another aspect of the present invention, the system consists of a lot of subsystems which will work simultaneously to make the launch.

In another aspect of the present invention, the said system can be used for multiple launches as it requires the least amount of maintenance.

In another aspect of the present invention, the launch can be frequently managed without any interruption. The next lined up vehicles are transported frequently.

### BRIEF DESCRIPTION OF THE DRAWINGS

The manner in which the proposed system works is given a more particular description below briefly summarized above, may be had by reference to the components, some of which are illustrated in the appended drawing. It is to be noted: however, that the appended drawing illustrates only typical embodiments of this system and therefore should not be considered limiting of its scope, for the system may admit to other equally effective embodiments.

Throughout the drawings, the same drawing reference numerals will be understood to refer to the same elements and features.

The features and advantages of the present proposed system will become more apparent from the following detailed description along with the accompanying figures, which forms a part of this application and in which:

FIG. 1 illustrates the launch vehicle assembled at the launcher in the assembly area in accordance with our present invention;

FIG. 2 illustrates the launcher with the launch vehicle being transported via road in accordance with our present invention;

FIG. 3 illustrates the launcher with the launch vehicle being transported via sea in accordance with our present invention;

FIG. 4 illustrates the launcher at the launch site before articulation in accordance with our present invention;

FIG. 5 illustrates the vehicle after articulation and the start of propellant filling in accordance with our present invention;

FIG. 6 illustrates the method of mobile orbital launcher in accordance with our present invention

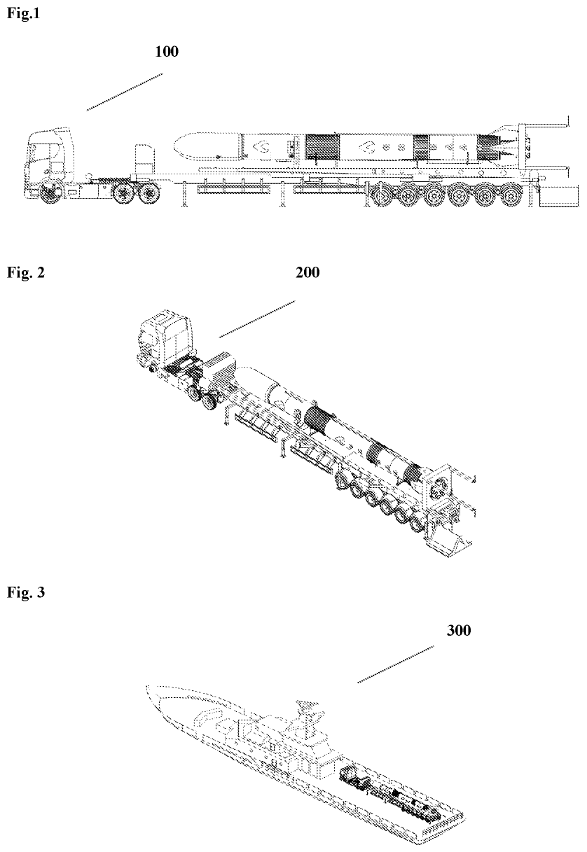

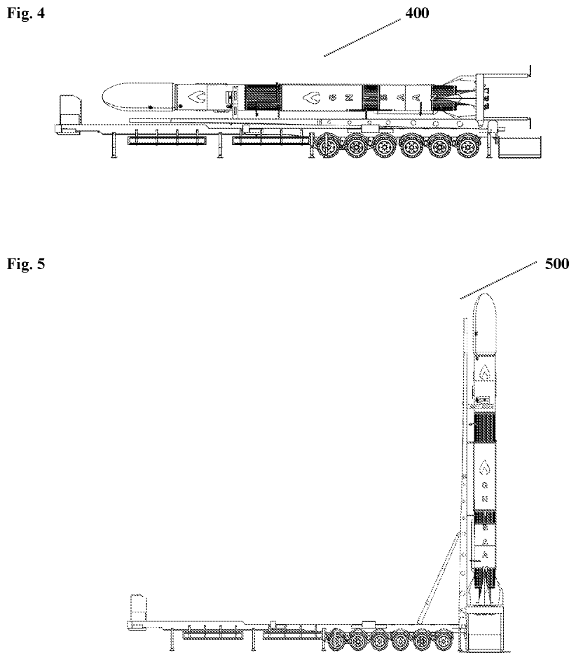

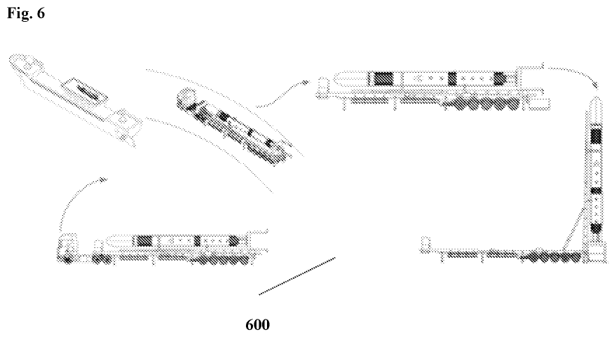

### REFERENCE NUMERALS

100 launch vehicles assembled at the launcher in the assembly area
200 launcher with the launch vehicle being transported via road
300 launcher with the launch vehicle being transported via sea
400 launcher at the launch site before articulation
500 vehicle after articulation and the start of propellant filling
600 process of satellite mobile launcher

### DETAILED DESCRIPTION OF THE INVENTION

The principles of operation, design configurations, and evaluation values in these non-limiting examples can be varied and are merely cited to illustrate at least one embodiment of the invention, without limiting the scope thereof.

The embodiments disclosed herein can be expressed in different forms and should not be considered as limited to the listed embodiments in the disclosed invention. The various embodiments outlined in the subsequent sections are constructed such that it provides a complete and a thorough understanding of the disclosed invention, by clearly describing the scope of the invention, for those skilled in the art.

The main element of the present invention is that the system can go to any desired location via road (200) or sea (300) to any required location and launch.

The system of the present invention has a highly modified trailer which can carry all the launch related subsystems on it along with the launch vehicle and is capable of going anywhere through land or sea.

The mobile launcher of the present invention mainly consists of the launch vehicle and launch related subsystems. All the systems fit on a trailer which is capable of going anywhere via road or sea. The mobile launcher carries the vehicle in a horizontal position and after reaching the required location, it articulates and makes the vehicle vertical to get ready for launch.

The system of the present invention has all the subsystems which can make this happen. Alternate ways to carry the launch system through the mode of air to the required location and launch.

The system of the present invention can go on the existing roads to reach the desired location This system is designed to take care of the vehicle while traveling and the system requires comparatively less maintenance.

The method of the present invention (600) includes launch vehicles assembled at the launcher in the assembly area (100); launcher with the launch vehicle being transported via road (200); launcher with the launch vehicle being transported via sea (300): launcher at the launch site before articulation (400): vehicle after articulation and the start of propellant filling (500):

The launch vehicle of the present invention along with its complete umbilical system will be carried out on a single trailer. During transportation the vehicle will be in horizontal position and it will be in completely dry condition. If the launch location is from sea or an ocean, we can carry the complete trailer on the ship to the desired location and make the launch.

Once the trailer reaches the launch location site, the vehicle will be articulated with the help of a tilt cylinder (hydraulic actuator) and make it vertical. Once the vehicle is articulated, the propellant and pressurant will be filled in the vehicle.

Advantages of the present invention include:
1. The system can carry our launch vehicle and launch related subsystem on the single trailer.
2. The system can go to any required location via land or sea and make the launch.
3. Less maintenance is required comparatively so launches are executed frequently.
4. No constraints in terms of the path to launching location are present as the current system can take both the road as well as sea routes.
5. The current invention saves time by making the launch at the required location.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope of the invention as claimed.

We claim:

1. A mobile orbital launcher system that is characterized by:
launch vehicle and launch related subsystems;
wherein systems will fit on a trailer which is capable of going anywhere via road or sea; and
the vehicle in a horizontal position.

2. The mobile orbital launcher system as claimed in claim 1 wherein the said subsystems related to launching on a vehicle can go through road or sea based on the requirement and launch at the required time.

3. The mobile orbital launcher system as claimed in claim 1 wherein the said vehicle after reaching the required location will articulate with the help of a tilt cylinder and make it vertical.

4. The mobile orbital launcher system as claimed in claim 1 wherein the said tilt cylinder is hydraulic actuator.

5. A method of mobile orbital launching system (600) comprising the steps of:
assembling the launch vehicles at the launcher in the assembly area (100);
transporting the launch vehicle with the launcher via road (200);
transporting the launch vehicle with the launcher via sea (300);
placing launcher at the launch site before articulation (400);
vehicle articulation and the start of propellant filling (500); and launching the vehicle.

6. The method of mobile orbital launching system (600) as claimed in claim 5 wherein the launch vehicle along with its complete system will be carried out on a single trailer.

7. The method of mobile orbital launching system (600) as claimed in claim 5 wherein during transportation the vehicle will be in horizontal position and it will be in completely dry condition.

8. The method of mobile orbital launching system (600) as claimed in claim 5 wherein the said articulated vehicle is filled with the propellant and pressurant.
